(19) United States
(12) Patent Application Publication
(10) Pub. No.: US 2025/0163336 A1
(43) Pub. Date: May 22, 2025

(54) SLURRY HYDROCRACKING OF RENEWABLE FEEDSTOCKS

(71) Applicant: CHEVRON U.S.A. INC., San Ramon, CA (US)

(72) Inventors: Bo KOU, Albany, CA (US); Shuwu YANG, Richmond, CA (US); Goutam BISWAS, Danville, CA (US); Theodorus Ludovicus Michael MAESEN, Spring, TX (US); Michelle K. YOUNG, Manvel, TX (US)

(21) Appl. No.: 18/944,638

(22) Filed: Nov. 12, 2024

Related U.S. Application Data
(60) Provisional application No. 63/599,671, filed on Nov. 16, 2023.

(51) Int. Cl. C10G 47/30; C10G 47/06

(52) U.S. Cl. CPC C10G 47/30; C10G 47/06; C10G 2300/1003; C10G 2300/1014; C10G 2300/4081; C10G 2400/04; C10G 2400/08

(57) ABSTRACT

The present disclosure provides a process for upgrading solid biomass feedstocks into more useable products. The process includes introducing a solid biomass feedstock, a liquid carrier, a slurry hydrocracking catalyst to a slurry hydrocracking zone in the presence of hydrogen and under slurry hydrocracking conditions to produce a slurry hydrocracking effluent comprising lighter hydrocarbonaceous products; wherein the liquid carrier is a hydrocracking recycle stream taken only from the slurry hydrocracking effluent; wherein the solid biomass feedstock and liquid carrier are combined upstream of the slurry hydrocracking zone to form a combined feed; the combined feed subsequently being introduced to the slurry hydrocracking zone.

### CROSS-REFERENCE TO RELATED APPLICATIONS

This application claims the benefit of and priority to U.S. Provisional Application No. 63/599,671 filed Nov. 16, 2023, the entire contents of which is incorporated herein by reference.

### FIELD

The present disclosure relates to a process for upgrading solid biomass feedstocks into more useable products by slurry hydrocracking.

### BACKGROUND

With increasing demand for liquid transportation fuels, decreasing reserves of ‘easy oil’ (crude petroleum oil that can be accessed and recovered easily) and increasing constraints on carbon footprints of such fuels, it is becoming increasingly important to develop routes to produce liquid transportation fuels from biomass in an efficient manner. Such liquid transportation fuels produced from biomass are sometimes also referred to as biofuels. Biomass offers a source of renewable carbon. Therefore, when using such biofuels, it may be possible to achieve more sustainable CO₂ emissions over petroleum-derived fuels.

Solid feedstocks such as feedstocks containing lignocellulose (e.g., woody biomass, agricultural residues, forestry residues, residues from the wood products and pulp & paper industries) and municipal solid waste are important feedstocks for biomass-to-fuel processes due to their availability on a large scale.

A two-step process is generally adopted for upgrading solid feedstocks to transportation fuels. The solid feedstock is first liquefied by pyrolysis, hydrolysis, hydrothermal liquefaction, etc. to produce bio-crude. The bio-crude is subsequently hydrotreated to reduce the viscosity and oxygen content to produce transportation fuel. Without hydrogenation, the liquefied bio-crude products have low quality (e.g., in terms of contaminants, stability, homogeneity, etc.) which can pose significant challenges for further upgrading at a downstream hydrotreating unit. Therefore, it is desirable to have high quality biocrude from liquefaction which can be directly upgraded in a hydrotreating unit.

### SUMMARY

The present disclosure relates to a continuous process for upgrading a solid biomass feedstock which comprises introducing a solid biomass feedstock, a liquid carrier, a slurry hydrocracking catalyst to a slurry hydrocracking zone in the presence of hydrogen and under slurry hydrocracking conditions to produce a slurry hydrocracking effluent comprising lighter hydrocarbonaceous products; wherein the liquid carrier is a hydrocracking recycle stream taken only from the slurry hydrocracking effluent; wherein the solid biomass feedstock and liquid carrier are combined upstream of the slurry hydrocracking zone to form a combined feed; the combined feed subsequently being introduced to the slurry hydrocracking zone.

### DETAILED DESCRIPTION

### Definitions

The term “hydrocracking”, as used herein, refers to a process in which hydrocarbons crack in the presence of hydrogen to lower molecular weight hydrocarbons. Hydrocracking also includes slurry hydrocracking in which feed is mixed with catalyst and hydrogen to make a slurry and cracked to lower boiling products.

The term “hydrotreating” refers to processes wherein a hydrogen-containing treat gas is used in the presence of suitable catalysts which are primarily active for the removal of heteroatoms, such as sulfur, nitrogen, oxygen and metals from the hydrocarbon feedstock. In hydrotreating, hydrocarbons with double and triple bonds such as olefins may be saturated. Aromatics may also be saturated. Some hydrotreating processes are specifically designed to saturate aromatics. In hydrotreating, a feed derived from a biological source is subjected to hydrodeoxygenation, decarboxylation and/or hydrodecarbonylation.

The term “Cn hydrocarbons” or “Cn”, is used herein having its well-known meaning, that is, wherein “n” is an integer value, and means hydrocarbons having that value of carbon atoms. The term “Cn+ hydrocarbons” or “Cn+” refers to hydrocarbons having that value or more carbon atoms. The term “Cn− hydrocarbons” or “Cn−” refers to hydrocarbons having that value or less carbon atoms.

The term “hydrocarbon” is used in the conventional sense to refer to a compound containing only carbon and hydrogen atoms.

The term “hydrocarbonaceous” can be used to refer to compounds, mixtures, and/or other fractions that are substantially composed of hydrocarbons or hydrocarbon-like compounds, but that may also include heteroatoms (i.e., not carbon or hydrogen). Examples of such heteroatoms include sulfur, nitrogen, oxygen, phosphorus and various trace metals such as alkali metals, alkaline earth metals and transition metals (e.g., iron). For a mixture or fraction, the combined carbon and hydrogen content of a hydrocarbonaceous mixture or fraction can correspond to at least 80 wt. % of the total weight of a mixture or fraction, or at least 90 wt. %, or at least 95 wt. %, or at least 98 wt. %, such as up to 100 wt. % (i.e., a hydrocarbon mixture or fraction is included within the definition for a hydrocarbonaceous fraction). It is noted that a hydrocarbonaceous sample can correspond to a portion of one or more hydrocarbonaceous compounds, mixtures, and/or fractions.

The term “continuous” means a system that operates without interruption or cessation for a period of time, such as where reactants are continually fed into a reaction zone and products are continually or regularly withdrawn without stopping the reaction in the reaction zone.

The term “biomass” refers to, without limitation, organic material originating from plants, animals, or micro-organisms (e.g., including plants, agricultural crops or residues, municipal wastes, and algae).

The term “renewable” refers to a material that is produced from a renewable resource, which is a resource produced via a natural process at a rate comparable to its rate of consumption (e.g., within a 100-year time frame). The renewable resource can be replenished naturally or via agricultural techniques. Non-limiting examples of renewable resources include plants, animals, fish, bacteria, fungi, and forestry products. These resources can be naturally occurring, hybrids, or genetically engineered organisms. Natural resources such as crude oil (petroleum), natural gas, coal, peat, etc. take longer than 100 years to form and thus they are not considered renewable resources.

The term “boiling point temperature” means atmospheric equivalent boiling point (AEBP) as calculated from the observed boiling temperature and the distillation pressure, as calculated using the equations furnished in ASTM D1160 appendix A7 entitled “Practice for Converting Observed Vapor Temperatures to Atmospheric Equivalent Temperatures”.

The term “T5” or “T95” means the temperature at which 5 volume percent or 95 volume percent, as the case may be, respectively, of the sample boils using ASTM D86.

The term “initial boiling point” (IBP) means the temperature at which the sample begins to boil using ASTM D86.

The term “end point” (EP) means the temperature at which the sample has all boiled off using ASTM D86.

The term “True Boiling Point” (TBP) means a test method for determining the boiling point of a material which corresponds to ASTM D2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

The term “naphtha” or “naphtha boiling range” means hydrocarbons boiling in the range of an IBP between about 0° C. and 100° C. or a T5 between 15° C. and 100° C. and the “naphtha cut point” comprising a T95 between 150° C. and 200° C. using the TBP distillation method.

The term “kerosene” or “kerosene boiling range” means hydrocarbons boiling in the range of from 132° C. to 300° C., using the TBP distillation method. Further, a kerosene stream may be defined as having T5 boiling point from 120° C. to 200° C. and T95 boiling point from 270° C. to 300° C. or a T10 boiling of no more than 205° C. and a final boiling point of no greater than 300° C. using ASTM D86. Furthermore, the flash point must be greater than about 38° C. using ASTM D56.

The term “diesel” or “diesel boiling range” means hydrocarbons having a T5 boiling point between 150° C. and 200° C. and a T95 boiling point between 343° C. and 399° C. using the TBP distillation method.

The term “vacuum gas oil” (VGO) as used herein refer to hydrocarbons boiling in the range of about 343° C. to 550° C. The term “light vacuum gas oil” (LVGO) refers to hydrocarbons boiling in the range of about 343° C. to 425° C. The term “heavy vacuum gas oil” (HVGO) refers to hydrocarbons boiling in the range of about 425° C. to 550° C.

The term “a component-rich stream” means that the rich stream coming out of a vessel has a greater concentration of the component than the feed to the vessel.

The terms “upgrade”, “upgrading” and “upgraded”, when used to describe a feedstock that is being or has been subjected to hydroprocessing, or a resulting material or product, refer to one or more of a reduction in molecular weight of the feedstock, a reduction in boiling point range of the feedstock, a reduction in concentration of hydrocarbon free radicals, and/or a reduction in quantity of impurities, such as sulfur, nitrogen, oxygen, halides, and metals.

The term “zone” can refer to an area including one or more equipment items and/or one or more sub-zones. Equipment items can include one or more reactors or reactor vessels, separation vessels, distillation towers, heaters, exchangers, pipes, pumps, compressors, and controllers. Additionally, an equipment item, such as a reactor, dryer, or vessel, can further include one or more zones or sub-zones.

The term “effluent” refers to a stream that is passed out of a reactor, a reaction zone, or a separator following a particular reaction or separation. Generally, an effluent has a different composition than the stream that entered the reactor, reaction zone, or separator. It should be understood that when an effluent is passed to another component or system, only a portion of that effluent may be passed. For example, a slipstream may carry some of the effluent away, meaning that only a portion of the effluent may enter the downstream component or system.

The terms “separation unit” and “separator” refer to any separation device(s) that at least partially separates one or more chemical constituents in a mixture from one another. For example, a separation system may selectively separate different chemical constituents from one another, forming one or more chemical fractions. Examples of separation systems include, without limitation, distillation columns, fractionators, flash drums, knock-out drums, knock-out pots, centrifuges, filtration devices, traps, scrubbers, expansion devices, membranes, solvent extraction devices, high-pressure separators, low-pressure separators, or combinations or these. The separation processes described in the present disclosure may not completely separate all of one chemical constituent from all of another chemical constituent. Instead, the separation processes described in the present disclosure “at least partially” separate different chemical constituents from one another and, even if not explicitly stated, separation may include only partial separation.

It should further be understood that streams may be named for the components of the stream, and the component for which the stream is named may be the major component of the stream (such as comprising from 50 wt. %, from 70 wt. %, from 90 wt. %, from 95 wt. %, from 99 wt. %, from 99.5 wt. %, or from 99.9 wt. % of the contents of the stream to 100 wt. % of the contents of the stream). It should also be understood that components of a stream are disclosed as passing from one system component to another when a stream comprising that component is disclosed as passing from that system component to another. For example, a disclosed “hydrogen stream” passing to a first system component or from a first system component to a second system component should be understood to equivalently disclose “hydrogen” passing to the first system component or passing from a first system component to a second system component.

The terms “wt. %”, “vol. %” or “mol. %” refers to a weight, volume, or molar percentage of a component, respectively, based on the total weight, the total volume, or the total moles of material that includes the component. In a non-limiting example, 10 moles of component in 100 moles of the material is 10 mol. % of component.

### Solid Biomass Feedstock

The process is capable of processing a wide range of solid biomass feedstocks. Suitable biomass feedstocks include: (1) agricultural residues, such as corn stalks, straw, seed hulls, sugarcane leavings, bagasse, nutshells, and manure from cattle, poultry, and hogs; (2) wood materials, such as wood or bark, sawdust, timber slash, and mill scrap; (3) municipal waste, such as waste paper and yard clippings; (4) algae-derived biomass, including carbohydrates and lipids from microalgae (e.g., Botryococcus braunii, Chlorella, Dunaliella tertiolecta, Gracilaria, Pleurochyrsis carterae, and Sargassum) and macroalgae (e.g., seaweed); and (5) energy crops, such as poplars, willows, switch grass, miscanthus, sorghum, alfalfa, prairie bluestem, corn, soybean, and the like.

The solid biomass material may be washed, dried, roasted, torrefied and/or reduced in particle size before it is used as a feedstock in step (a). The solid biomass feedstock may be supplied or be present in a variety of forms, including chips, pellets, powder, chunks, briquettes, crushed particles, milled particles, ground particles or a combination of two or more of these.

### Liquid Carrier

The solid biomass feedstock is dispersed in a liquid carrier to make a slurry which can be fed to a slurry hydrocracking zone. The liquid carrier is produced exclusively in situ during the continuous slurry hydrocracking process and is an internal hydrocracking recycle stream from a separation unit in the slurry hydrocracking zone. The hydrocracking recycle stream may comprise naphtha boiling range components, diesel boiling range components, vacuum gas oil boiling range components, or any combination thereof.

The slurry hydrocracking is conducted in the absence of an external liquid carrier. The term “external liquid carrier” refers to a liquid carrier that does not originate from the hydrocracking process itself but rather is added to the reactor system from another source.

The weight ratio of liquid carrier to solid biomass feedstock can range from about 0.1:1 to about 20:1. The ratio of renewable liquid carrier to solid biomass feedstock may be about 0.5:1, about 1:1, about 2:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1, and ranges including and between any two of these values.

### Slurry Hydrocracking

Slurry hydrocracking processes for preparing one or more upgraded hydrocarbonaceous products generally involve passing the solid biomass feedstock and liquid carrier, as described above, through a slurry hydrocracking reaction zone in the presence of hydrogen and a slurry hydrocracking catalyst under slurry hydrocracking conditions to provide a slurry hydrocracking effluent comprising lighter liquid hydrocarbonaceous products.

The slurry hydrocracking process uses a dispersed catalyst which is continuously doped into the feed.

In some embodiments, the catalyst can correspond to one or more catalytically active metals in particulate form and/or supported on particles.

Catalytically active metals for use in slurry hydrocracking can include those from Groups 4-12 of the IUPAC Periodic Table of Elements. Examples of suitable metals include iron, nickel, molybdenum, zinc, vanadium, tungsten, cobalt, ruthenium, and any combination thereof. The catalytically active metal may be present as a solid particulate in elemental form or as an organic compound or an inorganic compound such as a sulfide or other ionic compound. Metal or metal compound nanoaggregates may also be used to form the solid particulates.

A catalyst in the form of a solid particulate is generally a compound of a catalytically active metal, or a metal in elemental form, either alone or supported on a refractory material such as an inorganic metal oxide (e.g., alumina, silica, titania, zirconia, and any combination thereof). Other suitable refractory materials can include carbon, coal, and clays. Zeolites and non-zeolitic molecular sieves are also useful as solid supports. Generally, supported catalyst can have from 0.01 to 30 wt. % of the catalytic active metal based on the total weight of the catalyst.

In some embodiments, it can be desirable to form catalyst for slurry hydrocracking in situ, such as forming catalyst from a metal sulfate (e.g., iron sulfate monohydrate) catalyst precursor or another type of catalyst precursor that decomposes or reacts in the hydrocracking reaction zone environment, or in a pretreatment step, to form a desired, well-dispersed and catalytically active solid particulate (e.g., as iron sulfide). Precursors also include oil-soluble organometallic compounds containing the catalytically active metal of interest that thermally decompose to form the solid particulate (e.g., iron sulfide) having catalytic activity. Other suitable precursors include metal oxides that may be converted to catalytically active (or more catalytically active) compounds such as metal sulfides. In a particular embodiment, a metal oxide containing mineral may be used as a precursor of a solid particulate comprising the catalytically active metal (e.g., iron sulfide) on an inorganic refractory metal oxide support (e.g., alumina).

In some embodiments, the slurry hydrocracking catalyst comprises one or more of molybdenum sulfide, iron sulfide, nickel sulfide, zinc sulfide, and iron zinc.

The amount of catalyst in the process may be less than 5% by weight of the combined weight of the solid biomass feedstock and the liquid carrier. Preferably, the amount of catalyst in the process may be in the range of 0.005 to 3% by weight of the combined weight of the solid biomass feedstock and the liquid carrier, such as in the range of 0.02 to 1% by weight of the combined weight of the solid biomass feedstock and the liquid carrier.

Slurry catalysts used in conjunction with the processes described herein may have an average particle size of about 250 microns or less (e.g., 100 microns or less, or 10 microns or less). In some embodiments, the minimum average particle size of the slurry catalyst may be 1 micron. The particle size is the length of the largest orthogonal axis through the particle. Average particle size is the average particle diameter of all the catalyst particles fed to the reactor which may be determined by a representative sampling.

The slurry hydrocracking process can be operated at a moderate pressure, in a range of from 300 psig to 3500 psig (2.1 MPa to 24.1 MPa), or 1000 psig to 2500 psig (6.9 MPa to 17.2 MPa). The reactor temperature is typically in the range of from 300° C. to 450° C., or 330° C. to 400° C. The liquid hourly space velocity (LHSV) is typically below 4 h⁻¹ on a fresh feed basis, with a range of from 0.1 h⁻¹ to 3 h⁻¹, or 0.1 h⁻¹ to 1 h⁻¹. The amount of hydrogen treat gas used for slurry hydrocracking can be up to 8000 scf/B (1425 m³/m³), or up to 10000 scf/B (1781 m³/m³) or more.

The solid biomass feedstock, liquid carrier and optionally catalyst can be combined in any order in a mixing vessel situated upstream and in fluid connection with a reactor in the slurry hydrocracking zone to form a combined feed; the combined feed subsequently being introduced to the reactor in the slurry hydrocracking zone. In some embodiments, additional liquid carrier may be supplied to the slurry hydrocracking zone as a separate stream.

The slurry hydrocracking catalyst may be preloaded/supported onto the solid biomass feedstock, premixed with the liquid carrier, and/or blended into the combined feed. Additionally or alternatively, slurry hydrocracking catalyst may be supplied to the slurry hydrocracking zone as a separate stream.

Slurry hydrocracking can be carried out in a variety of reactors. Examples of reactors that can be used herein include continuous stirred tank reactors, fluidized bed reactors, spouted bed reactors, spray reactors, bubble column reactors, liquid recirculation reactors, slurry recirculation reactors, and combinations thereof. In one embodiment, the reactor is an up-flow reactor. In another embodiment, the reactor is a down-flow reactor. Generally, the vapor outlet from slurry hydrocracking reactor is above the inlet. The slurry outlet may be above or below the inlet. One or more slurry hydrocracking reactors may be utilized in parallel or in series. In contrast to conventional integrated hydropyrolysis and hydroconversion (IH²) technology where catalyst is fluidized or suspended by means of a gas (e.g., hydrogen), the process of this disclosure uses a slurry reactor wherein solids and catalyst are dispersed in liquid.

The slurry hydrocracking effluent can be sent to a separator where the effluent is separated into a hydrogen rich off gas stream and a bottoms liquid stream. The separator can include one or more separators (e.g., a hot separator operated at between about 260° C. and 426° C. and preferably at about the pressure of the hydrocracking reactor and a cold separator operated at between about 60° C. and 300° C. and a pressure of about the pressure of the hot separator).

The bottoms liquid stream can be separated into two or more streams. For example, there can be a naphtha and diesel stream, which can be further processed, such as by hydrotreating. Another stream could be a light vacuum gas oil (LVGO) stream. There could be a heavy vacuum gas oil (HVGO) stream. One or more of these streams can be recycled to the slurry hydrocracking reactor for use as the liquid carrier.

In some embodiments, the slurry hydrocracking effluent includes at least about 50 wt. % naphtha, kerosene and diesel range components, such as at least about 75 wt. % naphtha, kerosene and diesel range components, based on the total slurry hydrocracking effluent. In an exemplary embodiment, the slurry hydrocracking effluent includes from 15 wt. % to 30 wt. % naphtha range components and from 40 wt. % to 60 wt. % diesel range components, based on the total slurry hydrocracking effluent. Further, slurry hydrocracking effluent can include about 30 wt. % or less (e.g., 20 wt. % or less, or 10 wt. % or less) heavier components, such as components having boiling points of greater than 343° C.

### Hydrotreating

In a hydrotreating reactor, a hydrotreating feed stream taken from the slurry hydrocracking effluent may be hydrotreated in the presence of hydrogen over a hydrotreating catalyst to produce a hydrotreated stream comprising naphtha and diesel range hydrocarbons. Essentially, the hydrotreating reaction removes heteroatoms from hydrocarbonaceous materials and saturates olefins in the feed stream.

The catalysts used for hydrotreating can include conventional hydroprocessing catalysts, such as those that comprise at least one Group 8-10 non-noble metal, preferably Fe, Co, and/or Ni, such as Co and/or Ni; and at least one Group 6 metal, preferably Mo and/or W. Such hydroprocessing catalysts optionally include transition metal sulfides that are impregnated or dispersed on a refractory support or carrier such as alumina and/or silica. The support or carrier itself typically has no significant/measurable catalytic activity. Substantially carrier- or support-free catalysts, commonly referred to as bulk catalysts, generally have higher volumetric activities than their supported counterparts.

The catalysts used for hydrotreatment can include conventional hydrotreating catalysts, such as those that comprise at least one Group 8-10 non-noble metal, preferably Fe, Co, and/or Ni, such as Co and/or Ni; and at least one Group 6 metal, preferably Mo and/or W. Such hydrotreating catalysts can optionally include transition metal sulfides. These metals or mixtures of metals are typically present as oxides or sulfides on refractory metal oxide supports. Suitable metal oxide supports include low acidic oxides such as silica, alumina, silica-alumina, silica-titania, and titania-alumina. Suitable aluminas are porous aluminas such as gamma or eta having average pore sizes from 50 to 200 Å, or 75 to 150 Å; a surface area from 100 to 300 m²/g, or 150 to 250 m²/g; and a pore volume of from 0.25 to 1.5 cm³/g, 0.30 to 1.0 cm³/g, or 0.35 to 0.8 cm³/g. The supports are preferably not promoted with a halogen such as fluorine as this generally increases the acidity of the support.

The at least one Group 8-10 non-noble metal, in oxide form, can typically be present in an amount ranging from 2 wt. % to 40 wt. % (e.g., 4 wt. % to 15 wt. %). The at least one Group 6 metal, in oxide form, can typically be present in an amount ranging from 2 wt. % to 70 wt. % (e.g., 6 wt. % to 40 wt. %, or 10 wt. % to 30 wt. %). These weight percents are based on the total weight of the catalyst. Suitable metal catalysts include cobalt/molybdenum (1-10% Co as oxide, 10-40% Mo as oxide), nickel/molybdenum (1 to 10% Ni as oxide, 10-40% Co as oxide), or nickel/tungsten (1 to 10% Ni as oxide, 10-40% W as oxide) on alumina, silica, silica-alumina, or titania.

Alternatively, the hydrotreating catalyst can be a bulk metal catalyst, or a combination of stacked beds of supported and bulk metal catalyst. By “bulk metal”, it is meant that the catalysts are unsupported wherein the bulk catalyst particles comprise 30 to 100 wt. % of at least one Group 8-10 non-noble metal and at least one Group 6 metal, based on the total weight of the bulk catalyst particles, calculated as metal oxides and wherein the bulk catalyst particles have a surface area of at least 10 m²/g. It is furthermore preferred that the bulk metal hydrotreating catalysts used herein comprise 50 to 100 wt. % (e.g., 70 to 100 wt. %) of at least one Group 8-10 non-noble metal and at least one Group 6 metal, based on the total weight of the particles, calculated as metal oxides.

Bulk catalyst compositions comprising one Group 8-10 non-noble metal and two Group 6 metals are preferred. The molar ratio of Group 6 to Group 8-10 non-noble metals can range from 20:1 to 1:20 (e.g., 10:1 to 1:10, or 3:1 to 1:3). If more than one Group 6 metal is contained in the bulk catalyst particles, the ratio of the different Group 6 metals is generally not critical. The same holds when more than one Group 8-10 non-noble metal is applied. In the case where Mo and W are present as Group 6 metals, the Mo:W ratio can range from 9:1-1:9. Preferably the Group 8-10 non-noble metal comprises Ni and/or Co. It is further preferred that the Group 6 metal comprises a combination of Mo and W. Preferably, combinations of Ni/Mo/W and Co/Mo/W and Ni/Co/Mo/W are used. The metals are preferably present as oxidic compounds of the corresponding metals, or if the catalyst composition has been sulfided, sulfidic compounds of the corresponding metals.

It is also preferred that the bulk metal hydrotreating catalysts used herein have a surface area of at least 50 m²/g and more preferably of at least 100 m²/g. It is also desired that the pore size distribution of the bulk metal hydrotreating catalysts be approximately the same as the one of conventional hydrotreating catalysts. Bulk metal hydrotreating catalysts can have a pore volume of from 0.05 to 5 cm³/g (e.g., 0.1 to 4 cm³/g, or 0.1 to 3 cm³/g, or 0.1 to 2 cm³/g), as determined by nitrogen adsorption. Preferably, pores smaller than 1 nm are not present. The bulk metal hydrotreating catalysts can have a median diameter of at least 10 nm, at least 50 nm, or at least 100 nm.

The hydrotreating is carried out in the presence of hydrogen. A hydrogen stream is, therefore, fed or injected into a vessel or reaction zone or hydroprocessing zone in which the hydroprocessing catalyst is located. Hydrogen, which is contained in a hydrogen “treat gas”, is provided to the reaction zone. Treat gas can be either pure hydrogen or a hydrogen-containing gas, which is a gas stream containing hydrogen in an amount that is sufficient for the intended reaction(s), optionally including one or more other gases (e.g., nitrogen and light hydrocarbons such as methane). The treat gas stream introduced into a reaction stage will preferably contain at least about 50 vol. % and more preferably at least about 75 vol. % hydrogen. Optionally, the hydrogen treat gas can be substantially free (less than 1 vol. %) of impurities such as H₂S and NH₃ and/or such impurities can be substantially removed from a treat gas prior to use. Hydrogen can be supplied co-currently with the input feed to the hydrotreatment reactor and/or reaction zone or separately via a separate gas conduit to the hydrotreatment zone.

Hydrotreating conditions can include a temperature of from 200° C. to 450° C., or 315° C. to 425° C.; a pressure of from 250 psig to 5000 psig (1.8 MPa to 34.6 MPa) or 300 psig to 3000 psig (2.1 MPa to 20.8 MPa); and a liquid hourly space velocity (LHSV) of from 0.1 h⁻¹ to 10 h⁻¹; and a hydrogen treat rate of from 200 scf/B to 10000 scf/B (35.6 m³/m³ to 1781 m³/m³), or 500 scf/B to 10000 scf/B (89 m³/m³ to 1781 m³/m³).

Any convenient type of reactor, such as fixed-bed (for example, trickle bed) reactors can be used for hydrotreating.

The hydrotreated stream from the hydrotreating reactor can be sent to a separation zone. The separation zone could include one or more distillation columns. There the hydrotreated stream can be separated into multiple distillate streams. In some embodiments, the hydrotreated stream is separated into at least a naphtha product fraction and a diesel product fraction. In other embodiments, there would also be a heavy hydrocarbon product fraction, the heavy hydrocarbon product having components with boiling points of greater than 343° C.

### EXAMPLES

The following examples are offered for illustrative purposes and are not intended to limit the disclosure in any manner.

### Example 1

The feed to a slurry hydrocracking unit consisted of the following materials shown in Table 1. The solid biomass was sawdust.

TABLE 1

| Feed | Flow Rate [MTPH] |
|---|---|
| Solid Biomass | 100.00 |
| Catalyst | 0.23 |
| Hydrogen | 21.99 |
| Total | 122.22 |

The solid biomass was dispersed in a liquid carrier and pumped to the reactor. The liquid carrier was the internal recycle from the fractionation section after the reactor. The flow rate of liquid carrier (i.e., internal recycle of liquid) was 400 metric tons per hour (MTPH). The product yield generated by model is shown in Table 2.

TABLE 2

| Product | Flow Rate [MTPH] |
|---|---|
| H₂O | 40.81 |
| CO | 8.80 |
| CO₂ | 3.60 |
| C1 | 5.10 |
| C2 | 2.90 |
| C3 | 2.90 |
| C4 | 2.30 |
| C5-350° F. | 20.80 |
| 350° F.-680° F. | 14.04 |
| >680° F. | 4.20 |
| Solid (catalyst + coke) | 2.06 |
| H₂S | 0.20 |
| NH₃ | 0.14 |
| Total | 107.56 |

1. A continuous process for upgrading a solid biomass feedstock, the process comprising:
introducing a solid biomass feedstock, a liquid carrier, a slurry hydrocracking catalyst to a slurry hydrocracking zone in the presence of hydrogen and under slurry hydrocracking conditions to produce a slurry hydrocracking effluent stream comprising lighter hydrocarbonaceous products;
wherein the liquid carrier is a hydrocracking recycle stream taken only from the slurry hydrocracking effluent;
wherein the solid biomass feedstock and liquid carrier are combined upstream of the slurry hydrocracking zone to form a combined feed; the combined feed subsequently being introduced to the slurry hydrocracking zone.

2. The process of claim 1, wherein the solid biomass feedstock is selected from the group consisting of agricultural residues, wood materials, municipal waste, algae-derived biomass, energy crops, and any combination thereof.

3. The process of claim 1, wherein the liquid carrier comprises naphtha boiling range components, diesel boiling range components, vacuum gas oil boiling range components, or any combination thereof.

4. The process of claim 1, wherein the slurry hydrocracking catalyst comprises solid catalyst particulates.

5. The process of claim 1, wherein the slurry hydrocracking catalyst comprises molybdenum sulfide, iron sulfide, nickel sulfide, zinc sulfide, iron zinc, or any combination thereof.

6. The process of claim 1, wherein the slurry hydrocracking catalyst is present in an amount of from 0.005% to 3% based on a combined weight of the solid biomass feedstock and the liquid carrier.

7. The process of claim 1, wherein the slurry hydrocracking zone comprises a fluidized bed reactor.

8. The process according to claim 1, wherein the slurry hydrocracking catalyst is preloaded onto the solid biomass feedstock, premixed into the liquid carrier, and/or blended with the combined feed.

9. The process according to claim 1, wherein the slurry hydrocracking catalyst is supplied to the slurry hydrocracking zone as a separate stream.

10. The process of claim 1, wherein a weight ratio of liquid carrier to solid biomass feedstock is in a range of from 0.1:1 to 20:1

11. The process of claim 1, wherein the slurry hydrocracking effluent comprises at least about 50 wt. % naphtha, kerosene and diesel range components, based on the total slurry hydrocracking effluent.

12. The process of claim 1, wherein the slurry hydrocracking effluent comprises at least about 75 wt. % naphtha, kerosene and diesel range components, based on the total slurry hydrocracking effluent.

13. The process of claim 1, wherein the slurry hydrocracking effluent comprises from 15 wt. % to 30 wt. % naphtha range components and from 40 wt. % to 60 wt. % diesel range components, based on the total slurry hydrocracking effluent.

14. The process of claim 1, further comprising:
hydrotreating in a hydrotreating reactor a hydrotreating feed stream taken from the slurry hydrocracking effluent in the presence of hydrogen over a hydrotreating catalyst to produce a hydrotreated stream; and
separating the hydrotreated stream into at least two hydrocarbon fractions in a separation zone, wherein the at least two hydrocarbon fractions comprise at least a naphtha product fraction and a diesel product fraction.
